(19) United States
(12) Patent Application Publication
(10) Pub. No.: US 2026/0257351 A1
(43) Pub. Date: Sep. 3, 2026

(54) AUTONOMOUS HUMAN-ROBOT INTERACTION VIA DIFFUSION-BASED OPERATOR IMITATION

(71) Applicant: DISNEY ENTERPRISES, INC., Burbank, CA (US)

(72) Inventors: Sammy Joe Christen, Lucerne (CH); Agon Serifi, Zürich (CH); David Mueller, Winterthur (CH); Ruben Jelle Grandia, Zürich (CH); Lars Espen Knoop, Birmensdorf (CH); Moritz Niklaus Bächer, Zürich (CH); Georg Wiedebach, Glendale, CA (US); Michael Anthony Hopkins, Pasadena, CA (US); Jenny Wang, Pittsburgh, PA (US)

(21) Appl. No.: 19/550,668

(22) Filed: Feb. 26, 2026

Related U.S. Application Data
(60) Provisional application No. 63/764,722, filed on Feb. 28, 2025.

(51) Int. Cl. B25J 9/16; G06N 3/08

(52) U.S. Cl. CPC B25J 9/163; G06N 3/08

(57) ABSTRACT

A method of training a diffusion model to enable autonomous interaction between a robotic device and a human includes receiving an operator command for the robotic device and pose data including a history of poses. The method includes applying noise to the operator command and encoding the noisy operator command, pose data, and history of operator commands into input tokens. The method includes inputting the tokens into a transformer encoder of the diffusion model and training the model to perform denoising to generate an autonomous command from the noisy operator command based on the pose data and command history. The method includes generating the autonomous command based on the transformer encoder output and executing the command to cause the robotic device to perform an action during autonomous interaction with the human.

### CROSS REFERENCE TO RELATED APPLICATIONS

This application claims the benefit of priority under 35 U.S.C. § 119 (e) and 37 C.F.R. § 1.78 to provisional application No. 63/764,722 filed on Feb. 28, 2025, titled “AUTONOMOUS HUMAN-ROBOT INTERACTION VIA DIFFUSION-BASED OPERATOR IMITATION,” which is hereby incorporated by reference herein in its entirety.

### FIELD

The present application relates to systems and methods for autonomously controlling robotic device/human interactions.

### BACKGROUND

As robots become more ubiquitous, the situations in which a robotic device may interact with a human increase. Traditional training of robots focuses on enabling the robotic device to move stably and reliably within its environment. However, interactions between robots and humans are either avoided (e.g., the robotic device is physically separated from people), or the robotic device is at least partially controlled by an operator who guides the interaction of the robotic device with other people via a remote control. Better systems are needed to enable robots to autonomously interact with people.

In human-robotic device interaction (HRI), existing platforms often either define heuristics or rely on remote operation of such robots by an operator, through simple-to-use interfaces like gamepads. However, transitioning towards autonomous human-robotic device interactions through imitation learning presents significant challenges, primarily due to the need for expensive data collection. This process itself depends on starting with a stable and expressive robotic device. Advancements in robotics have greatly enhanced their expressiveness, enabling robots to perform a diverse range of complex motions under remote operation. Results have been achieved in training robots in simulation and transferring them to a variety of legged robots (e.g., quadruped or bipedal robots). One important aspect of bringing these systems into the real world is creating robots that can interact with humans in natural and engaging ways. Other systems focus on task-specific behavior, such as table-carrying, or shared autonomy, where the robotic device is still controlled by an operator with assistance from an autonomous agent. An open challenge is to enable mobile robotic devices to engage with humans autonomously in unstructured environments, i.e., without any task-specific goals.

Recent research has developed robotic devices that can express a rich set of behaviors and human interactions through remote operation, such as for quadrupeds or bipedal robots, where high-level commands provided by an operator through gamepads are translated by a policy into stable and expressive robotic device actions. This enables robots to react to human behavior and even express different moods. For example, a shy robotic device follows a human while keeping a safe distance and looking towards the ground, whereas a joyful robotic device runs closely behind the human and initiates dancing motions from time to time. However, such control systems cannot enable robots to autonomously engage with humans in non-physical interactions (i.e., without contacts) and express different moods at a level comparable to remote operation.

There are multiple challenges involved with building such an expressive, autonomous system for HRI. Defining heuristics does not scale well, requires expert knowledge of the specific robotic device, and may have to be re-defined per robotic device. Similar challenges arise with defining rewards for a reinforcement learning policy, with the additional challenge of determining how to simulate humans realistically. Another option is to collect real-world data and train supervised models, a popular approach in robotic manipulation. In the context of HRI, collecting such data can be time-consuming and requires an already controllable robotic platform. The recent progress in operator-controllable robots through gamepads holds promise to make data-collection in such settings easier. However, such gamepads often comprise joysticks and buttons. With joysticks, continuous dimensions can be controlled, such as turning the torso to a target angle. Buttons, on the other hand, are often used to trigger pre-defined discrete events, such as switching from walking to standing. Existing models for real-time control of robotic devices typically focus on continuous predictions only.

### BRIEF SUMMARY

In one embodiment, a method of training a diffusion model to enable autonomous interaction between a robotic device and a human is provided. The method includes receiving, via a processing element, an operator command for the robotic device. The method includes receiving, via the processing element, pose data including a history of poses. The method includes applying, via the processing element, noise to the operator command to generate a noisy operator command. The method includes encoding, via the processing element, the noisy operator command, the pose data, and a history of operator commands into a plurality of input tokens. The method includes inputting, via the processing element, the plurality of input tokens into a transformer encoder of the diffusion model. The method includes training, via the processing element, the diffusion model to perform a denoising operation to generate an autonomous command from the noisy operator command based on the pose data and the history of operator commands. The method includes generating, via the processing element, the autonomous command based on an output of the transformer encoder. The method includes executing, via the robotic device, the autonomous command to cause the robotic device to perform an action during the autonomous interaction between the robotic device and the human.

Optionally, in some embodiments, the method further includes augmenting the pose data in a height dimension by adding a random offset during the training.

Optionally, in some embodiments, the method further includes masking, via the processing element, one or more of the plurality of input tokens or the output of the transformer encoder. The masking is applied after encoding by the transformer encoder.

Optionally, in some embodiments, the pose data further includes a pose of the robotic device.

Optionally, in some embodiments, the method further includes decoding, via the processing element, the output of the transformer encoder into at least one continuous event prediction.

Optionally, in some embodiments, the operator command includes a continuous command, and the method further includes determining, via the processing element, an error between the at least one continuous event prediction and the operator command.

Optionally, in some embodiments, the processing element determines the error based on an I²-loss function.

Optionally, in some embodiments, the method further includes decoding, via the processing element, the output of the transformer encoder into at least one discrete event prediction.

Optionally, in some embodiments, the operator command includes a discrete command, and the method further includes determining, via the processing element, an error between the at least one discrete event prediction and the operator command.

Optionally, in some embodiments, the processing element determines the error based on a cross-entropy function.

In one embodiment, a system for training a robotic device to autonomously interact with a human is provided. The system includes a robotic device. The system includes a controller in communication with the robotic device and configured to receive an operator command for the robotic device. The system includes a perceptive input system configured to determine pose data including a history of poses. The system includes a processing element configured to apply noise to the operator command to generate a noisy operator command, encode the noisy operator command, the pose data, and a history of operator commands into a plurality of input tokens, input the plurality of input tokens into a transformer encoder of a diffusion model, train the diffusion model to perform a denoising operation to generate an autonomous command from the noisy operator command based on the pose data and the history of operator commands, and generate the autonomous command based on an output of the transformer encoder. The robotic device is configured to execute the autonomous command to cause the robotic device to perform an action during the autonomous interaction with the human.

Optionally, in some embodiments, the processing element is further configured to augment the pose data in a height dimension by adding a random offset during the training.

Optionally, in some embodiments, the processing element masks one or more of the plurality of input tokens or the output of the transformer encoder, and the masking is applied after encoding by the transformer encoder.

Optionally, in some embodiments, the pose data further includes a pose of the robotic device.

Optionally, in some embodiments, the processing element decodes the output of the transformer encoder into at least one continuous event prediction.

Optionally, in some embodiments, the operator command includes a continuous command, and the processing element is configured to determine an error between the at least one continuous event prediction and the operator command.

Optionally, in some embodiments, the processing element determines the error based on an I² loss function.

Optionally, in some embodiments, the processing element decodes the output of the transformer encoder into at least one discrete event prediction.

Optionally, in some embodiments, the operator command includes a discrete command and the processing element is configured to determine a second error between the at least one discrete event prediction and the operator command.

Optionally, in some embodiments, the processing element determines the error based on a cross-entropy function.

### BRIEF DESCRIPTION OF THE DRAWINGS

FIG. 1 is a perspective view of an example of a robotic device.

FIG. 2 is a schematic of an existing system for controlling human/robotic device interactions.

FIG. 3 is a schematic of an embodiment of a system for training a robotic device of the present disclosure for autonomous human/robotic device interactions.

FIG. 4 is a schematic of an embodiment of an agent architecture for autonomously controlling human/robotic device interactions.

FIG. 5 is a flowchart of a method of training a robotic device for autonomous human/robotic device interactions using the system of FIG. 6.

FIG. 6 is a schematic of a system of the present disclosure for controlling human/robotic device interactions.

FIG. 7 is a simplified block diagram of components of a computing system of the robotic device of FIG. 1, or the systems of FIG. 3 or FIG. 6.

FIG. 8 is an example of test results of controlling a robotic device according to the systems and methods disclosed herein.

FIG. 9 is a flowchart of a method of training a robotic device for autonomous human/robotic device interactions using the system of FIG. 6.

### DETAILED DESCRIPTION

The present disclosure bridges the gap between expressive, remotely operated robots and autonomous human-robotic device interaction (HRI). Leveraging recent progress in enabling operators to control robots with a wide variety of behaviors through game-like interfaces, the disclosed embodiments capture a rich dataset of human-robotic device interactions. The disclosure includes a method that learns autonomous interactions from this dataset through a diffusion model. Instead of directly learning the correspondence between human states and low-level robotic device actions, the problem formulation focuses on replicating the intuitive commands provided by operators, taking advantage of the abstraction offered by game-like interfaces for controlling robots. In some embodiments, the disclosed systems and methods may demonstrate that with less than one hour of data, the methods may enable autonomous human-robotic device interactions, enable the robotic device to exhibit multiple moods, and/or switch between different modes such as walking and standing. The results indicate that the disclosed systems and methods outperform a transformer-based baseline and that people can recognize the mood of the robotic device. Additionally, people struggle to recognize whether the robotic device is remotely operated or autonomous, demonstrating the effectiveness of the disclosed systems and methods.

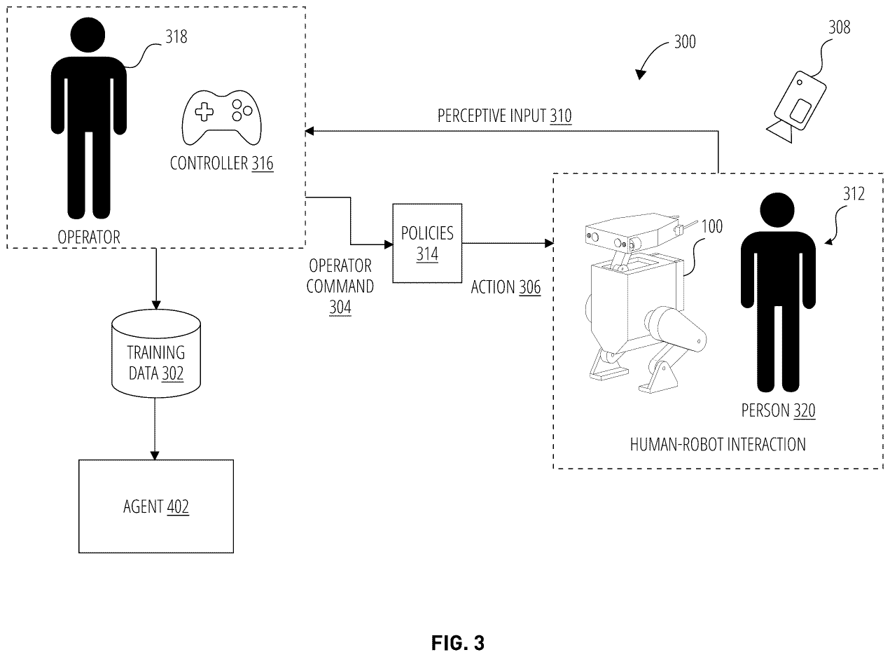

The present disclosure addresses challenges of existing methods with a new framework for training robots for human-robotic device interactions. In one embodiment, the method includes collecting a human-robotic device interaction dataset with an external operator that controls the robotic device to engage with a human (see, e.g., FIG. 3). The disclosed systems and methods record the robotic device and human state, along with the operator commands to control the robotic device. Using this dataset, the disclosed systems and methods formulate a problem statement for autonomous human-robotic device interactions. The methods and systems of the present disclosure focus on imitating the operator rather than imitating robotic device actions. This formulation has several advantages over re-learning low-level control actions. First, the space of operator outputs may be smaller than the space of the robotic device's actions, depending on the type of robotic device and/or operator. For example, a controller used by the operator may be able to generate commands that the robotic device cannot perform. Therefore, the amount of training data needed is drastically reduced through this approach. Second, using a generative model allows learning different reactions in similar situations, increasing the perceived liveliness and expressiveness compared to deterministic models. Third, the remote operation is typically designed for stable control of a robotic device through an operator interface-even if the operator inputs are adversarial. Hence, even if the model were to generate an unreasonable output, the robotic device would not fail or become unstable. Such stable control is especially important when interacting with humans.

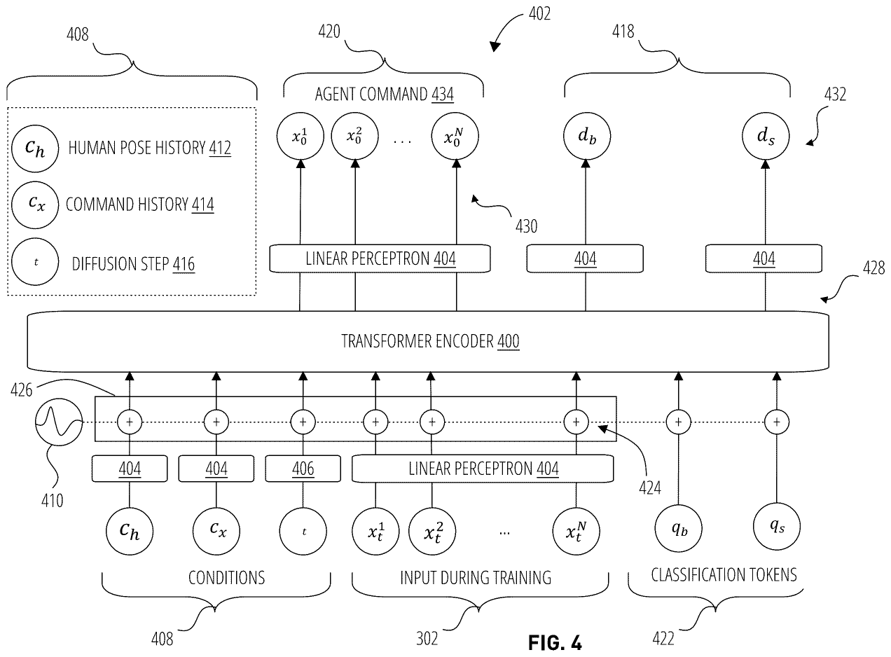

The disclosed systems and methods include effective techniques compared to previous diffusion-based frameworks to enable the disclosed systems and methods to work on real robotic platforms and engage with humans. First, the disclosed systems and methods add sensing of the human pose as condition to the model, enabling reactivity to the human's pose. Second, the disclosed systems and methods include both a diffusion-based part for predicting continuous signals and a classifier for predicting discrete events, all unified in a single transformer architecture (see, e.g., FIG. 4). Lastly, the disclosed systems and methods mask input signals during training after encoding, instead of masking before the encoding which may lead the model to learn wrong actions when the signal is zero.

Some examples of using the disclosed systems and methods show that, for example, by using less than one hour of data, the robotic device can learn to perform autonomous interactions, exhibit multiple moods, and switch between different styles of motion, such as walking, jumping, and/or standing, etc. In some examples, people may interact with a robotic device controlled with the disclosed systems and methods and evaluate whether the users can distinguish autonomous behavior of the robotic device from remote operation thereof. In other examples, people may guess the mood represented by the robotic device. In many examples, the disclosed approaches enable expressive human-robotic device interactions and people may struggle to distinguish between autonomous and operated interactions.

The disclosure includes 1) a novel system enabling autonomous human-robotic device interactions from a small amount of operator data compared to existing methods such a methods that attempt to map from a perceived human pose to low-level robotic device or actuator actions, instead of using a parametrized policy of the present disclosure that can perform certain low-level skills (walking, standing, etc.), 2) a model that imitates operator commands based on a human state and predicts both continuous and discrete signals, and 3) in some examples of use, systems and methods that can generate realistic human-robotic device interactions.

The present disclosure includes embodiments for systems and methods for training a robotic device to autonomously interact with humans or animals. In many embodiments, a robotic device may have a robust set of policies executed on a controller (such as an internal controller) that dictate how a robotic device moves. For example, a robotic device may have been trained to walk using one or more policies that govern the movements of the components of the robotic device (e.g., limbs, head, body, etc.) such that the robotic device maintains balance and can walk around obstacles or rough terrain. Thus, an operator can give such robotic devices simple commands that express the motion the robotic device should make and the policies govern how that motion is accomplished.

Examples of policy types suitable for use with many robotic devices include continuous motions that do not have a clear start and end (e.g., standing), periodic motions that animate repetitive actions (e.g., walking or running), and episodic motions that have a pre-defined duration (e.g., expressive or hero pose sequences). For example, a “hero” pose sequence may be one or more animations of the robotic device that resembles or give “life” to a character played by the robotic device. A hero pose sequence may also be an emotive or expressive animation that resembles or displays an emotional state (e.g., sadness, excitement, happiness, anger, curiosity, joy, shyness, etc.).

A robotic device may also include show functions that may be artistically controlled and/or synchronized with the overall motion of the robotic device, but do not affect the balance of the robotic device. Show functions can increase the emotive impact or expressiveness of the robotic device.

In many embodiments, the disclosed methods and systems include a diffusion-based agent trained to observe or otherwise receive indications of an interaction between a person and a robotic device and to autonomously control the robotic device to perform a motion or action that complements or reacts to the human interaction.

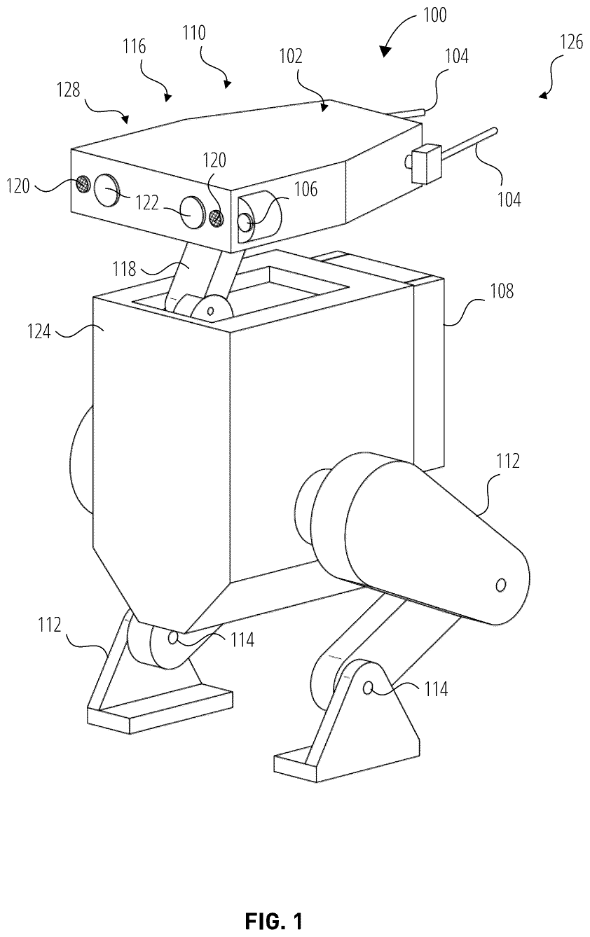

Turning to the figures, FIG. 1 shows an example of a robotic device 100 suitable to be controlled and trained with the methods and systems disclosed herein. In some examples, the robotic device 100 is as disclosed in U.S. patent application Ser. No. 18/658,153 filed May 8, 2024, entitled “Rapid Design and Animation of Freely-Walking Robotic Devices” and published as U.S. Patent Application Publication No. US20250108505A1, which is incorporated by reference herein in its entirety and for all purposes. The example robotic device shown is a bipedal character trained via reinforcement learning. The disclosed systems and methods provide an intuitive interface that translates operator inputs into actions, allowing rich expressiveness in robotic device outputs. The systems and methods disclosed herein are also suitable for other robotic devices than those disclosed in the above-referenced application.

In some examples, the robotic device 100 includes a body 124, two or more legs 112, and a head 128 supported on an articulated neck 118. The robotic device 100 may include one or more actuators 114 with integrated controllers, sensors (e.g., inertial measurement units “IMUs” 110), a controller 102 to facilitate communication and control of the robotic device 100 such as an on-board real-time or near real-time processor, an on-board battery 108 or power module, and/or a show function module 126 that integrates displays (e.g., to represent character's eyes 122), speakers 120, and other animated functions (e.g., moveable antennae 104, or other features). In this example, the robotic device 100 has five degrees of freedom in each leg 112 and four degrees of freedom in the neck 118, enabling it to perform motions such as walking, but also move the neck, head, and body independently as desired for different performances. Robotic devices with more or fewer degrees of freedom may also be trained with the methods and systems herein.

In many embodiments, the robotic device 100 has an on-board controller 102 interface to the actuator 114 hardware, such as actuators in the legs 112 and neck 118 via microcontroller-driven communications. The actuators 114 may have integrated motor drives, which implement low-level control loops (e.g., to control speed, location, torque, etc.), and/or built-in encoders to measure actuator 114 position (e.g., may generate state estimation of one or more portions of the robotic device 100). Actuators 114 may be interfaced to the communications interface 116. An inertial measurement unit 110 (as shown in FIG. 1 may be embedded in part of the exterior housing or otherwise concealed from view) may be coupled to the body 124 and is interfaced to the communications interface 116 (as shown in FIG. 1 may be embedded as part of the housing or otherwise concealed from view). An on-board battery 108 provides power to the actuators 114 and also the on-board controller 102 and other components.

The robotic device 100 may include show functions such as illuminated eyes 122, antennae 104, speakers 120 in the body 124 and/or in the head, and a head lamp 106. The show function module 126 can provide additional animation or expressiveness to the robotic device 100 without affecting the overall motion of its body 124. For example, the show function module 126 may be artistically controlled and synchronized with the overall motion of the robotic device 100, but does not affect the balance of the robotic device 100. As another example, the eyes 122 may illuminate and/or the antennae 104 may move, regardless of any motion of the legs 112, neck 118, etc. In some examples, a robotic device 100 may include more, fewer, or no show functions.

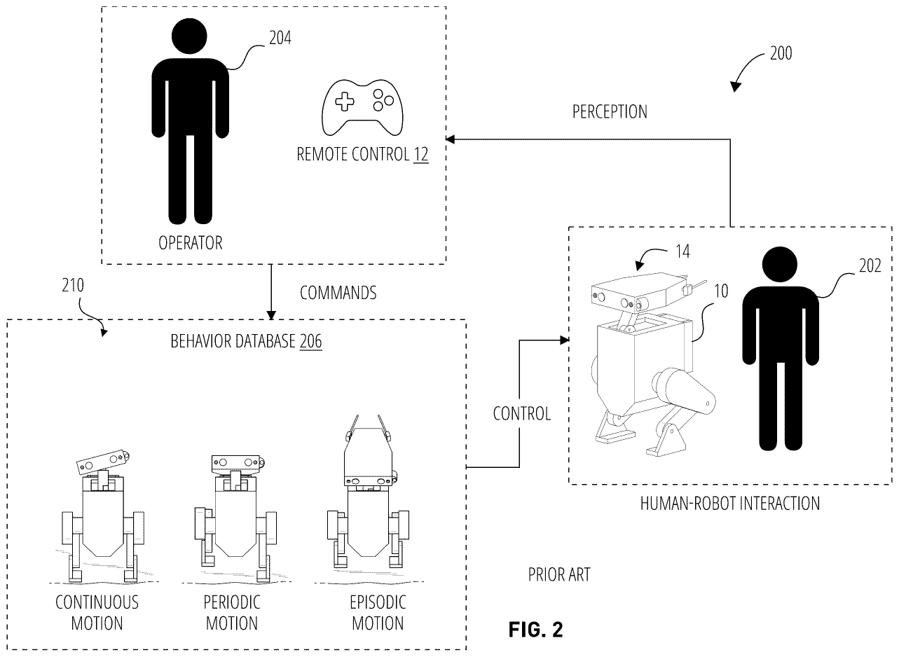

The controller 102 runs the robotic device 100 according to the policies the robotic device 100 was trained with (see, e.g., FIG. 2). The controller 102 receives commands for the robotic device 100 motion (e.g., from an external operator), and also receives the measurements of the state of the robotic device (e.g., inertial measurements from the IMU 110 and position, velocity, torque, force, acceleration, etc. measurement from actuators 114). The controller 102 also receives additional diagnostics information from the actuators 114 such as temperature and battery voltage.

Turning to FIG. 2, a previous system of controlling a robotic device 10 is shown. The system 200 includes the robotic device 10, an external controller 12, and a behavior database 206 that stores one or more policies executed by an internal control system 14 of the robotic device 10 that determine the robotic device 10 motion in various situations. To use the system 200, a person 202 may interact with the robotic device 10. While the person 202 interacts with the robotic device 10, an operator 204 may perceive the interaction between the robotic device 10 and the person 202. The operator 204 may issue one or more commands via the external controller 12. The commands may be received by the internal control system 14 of the robotic device 10 and processed by one or more policies 210 stored in the behavior database 206. The policies 210 may cause the internal control system 14 to move one or more portion of the robotic device 10, e.g., via an actuator. In many embodiments, the operator 204 may control the robotic device 10 from a location hidden from the view of the person 202. Such systems have a number of drawbacks. For example, the number of robotic devices 10 which can be deployed is limited by the availability of operators 204. Furthermore, it may be difficult for an operator 204 to accurately observe the person 202/robotic device 10 interaction from a location where the operator 204 is obscured from the person 202.

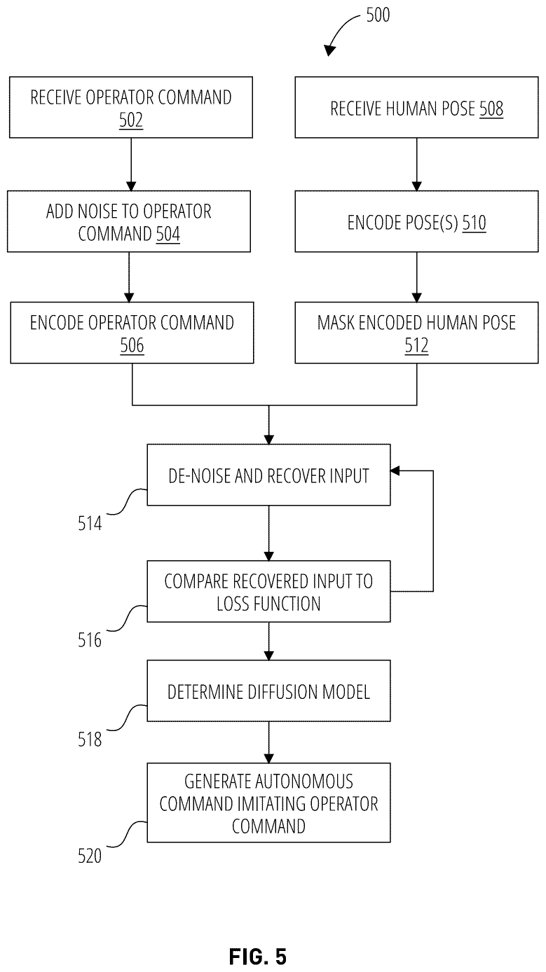

FIG. 3 is an example of a system 300 of the present disclosure for training an agent 402 to enable a robotic device 100 to autonomously interact with a person 320. In the system 300, a person 320 may interact with a robotic device 100. The operator 318 and/or a perception system 308 may perceive all or part of that interaction, such as a pose 312 of the robotic device 100 relative to the person 320, and generate a perceptive input 310. As used herein, a pose 312 may include one or more of a position, orientation, posture, or action. An operator 318 may control one or more aspects of the robotic device 100, such as triggering one or more policies 314 or show functions. Based on the perceptive input 310, the operator 318 may issue one or more operator commands 304 (e.g., via the control 316) received by the controller 102 and interpreted by the policies 314 to cause corresponding one or more actions 306 of the robotic device 100. In many embodiments, operator commands 304 are continuous commands (e.g., walk), discrete commands (e.g., turn on head lamp 106, trigger an episodic policy, etc.) or combinations of these. The policies 314 can take a combination of continuous (e.g., joysticks) and discrete (e.g., button presses) inputs. Policies 314 may serve as an abstraction layer that enables the robotic device to keep dynamic balance, independent of what the operator commands. The agent 402 may be trained based on either or both types continuous or discrete operator commands 304, or combinations thereof. The perceptive input 310 of the pose 312 (of either or both of the robotic device 100 and/or person 320) and/or the operator commands 304 may be included in training data 302 used to train the agent 402. Further description of the training is given with respect to FIG. 4 and FIG. 5.

In one example of a system 300, shown in FIG. 3 and includes: the robotic device 100, an operator 318 that controls the robotic device 100, a person 320 that interacts with the robotic device. The system 300 captures the human and/or robotic device poses 312, and the operator commands 304. In some embodiments, the system 300 records operator commands on the input interface. To capture human and robotic device 100 poses 312, is some embodiments, the perception system 308 is a motion capture system including at least one camera and at least one marker. Markers may be placed on the robotic device 100 and on a clothing item (e.g., a hat) or accessory that the person 320 is instructed to wear during data collection. The data-collection process encompasses multiple different types of interaction. The collection may vary between modeling different robotic device moods, such as a shy mood where the robotic device 100 often looks at the ground while interacting or following the human, or an angry mood where the robotic device shakes its head often and refuses interactions. Table 1 shows examples of collected data. In this example, the robotic device 100 is operated by a single operator and one, two, or more people interact with the robotic device 100. The lengths and types of the interactions shown in Table I are examples only. Other longer or shorter interactions may be used with the disclosed systems and methods. Other interactions than the categories shown for example in Table I are within the scope of the present disclosure.

TABLE I
MOTION TYPES, LENGTHS, AND DESCRIPTIONS

| | Length | |
|---|---|---|
| Category | (min) | Description |
| Default | 8 | Follows the human. retreats if the |
| | | human walks toward it, looks at the |
| | | human when in standing mode. |
| Angry | 6 | Ignores the human, walks away if |
| | | approached, shakes its head often, |
| | | occasionally triggers a tantrum hero |
| | | animation. |
| Sad | 8 | Walks away from the human, shakes |
| | | its head, looks mostly down at the |
| | | ground. |
| Shy | 7 | Approaches the human carefully, oc- |
| | | casionally stops, mostly looks at the |
| | | ground, and tries to avoid eye con- |
| | | tact. |
| Joyful | 8 | Turns in circles, runs after the hu- |
| | | man, and often expresses positiv- |
| | | ity through hero animations such as |
| | | dancing or jumping. |
| Skill- | 10 | Approaches and follows the human, |
| Showing | | demonstrating a variety of discrete |
| | | behaviors. Initiates a jump after the |
| | | human has jumped. |

FIG. 4 is a schematic of internal components of the agent 402 such as a diffusion transformer agent, and inputs thereto or outputs therefrom used in operation and/or training of the agent 402. The agent 402 includes a transformer encoder 400, such a diffusion encoder that processes inputs (e.g., a perceptive input 310 including a pose 312 of a person 320 and/or robotic device 100, etc.) and generates outputs based thereon.

Diffusion models are used in various domains such as the generation of images, videos or motion sequences. They are a family of generative models particularly well suited in modeling complex data distributions. Diffusion models comprise a forward (noising) and reverse (de-noising) process. The forward process is a discretization of Langevin dynamics, where in each step, Gaussian noise ϵₜ is added to a data sample x₀, leading to progressively nosier versions of that sample xₜ:

$${x}_{t} = \sqrt{1 - {β}_{t}} {x}_{t - 1} + \sqrt{{β}_{t}} {ϵ}_{t} , {ϵ}_{t} ∼ 𝒩 ( 0 , I ) . \qquad ( 1 )$$

Recursively applying the update yields

$$q ( {x}_{t} \vert {x}_{0} ) = 𝒩 ( {x}_{t} ; \sqrt{{{α}^{↼}}_{t}} {x}_{0} , ( 1 - {{α}^{↼}}_{t} ) I ) , \qquad ( 2 )$$

$${{α}^{↼}}_{t} = {{\prod }_{i = 1}}^{t} ( 1 - {β}_{i} ) , \qquad ( 3 )$$

Where βₜ is a is a variance scheduler for the noise, with t indicating the diffusion step. In the reverse process, the data is gradually denoised into a clean sample, which is modeled by the probability distribution p_{θ}(xₜ₋₁|xₜ). This denoising step is learned via a neural network parameterized by θ. The disclosed systems and methods directly predict a clean output Ro. Additionally, in conditional diffusion models, the probability distribution is extended by conditioning signals c, yielding p_{θ}(x₀|xₜ, c). During inference, the model can generate diverse outputs from randomly sampled Gaussian noise and the conditioning signals.

Given a sequence of human poses p and robotic device poses r, which each include global 3D position and 4D orientation in quaternions, a goal is to predict a future sequence of operator commands x^{1:N}, where N indicates the prediction horizon. Each operator command xₜ∈ [symbol] ^{k×1} contains several high-level signals of length l that are passed as conditioning to a policy that controls the robotic device 100. The disclosed systems and methods can predict continuous command predictions as well as predicting discrete events. In some embodiments, a discrete events trigger certain behavior d_{b}, such as a pre-defined jumping or a dancing motion and the style dₛ of the robotic device, e.g., whether it should be in standing or walking mode. Note that as used herein subscripts t indicate the diffusion step and superscript k describes the sequential prediction.

### Continuous Command Prediction Via Diffusion

To predict continuous operator commands, the agent 402 uses a diffusion model. More specifically, during training of the agent, the noising and denoising steps may be alternated.

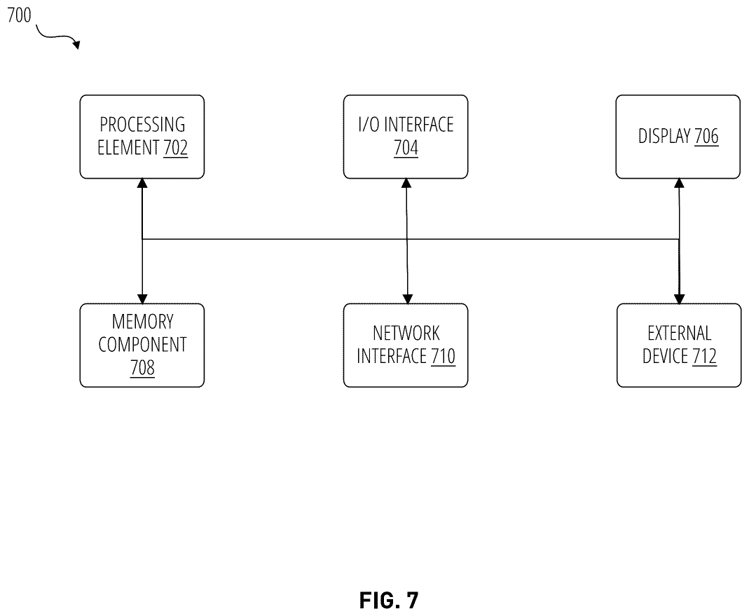

To train the agent 402, a processing element 702 (shown and described for example with respect to FIG. 7) of the system applies the separation of conditioning tokens and classifier-free guidance on past motion. The disclosed systems and methods remove dropout from the positional encoding and apply masking to the conditioning after the encoding layers instead of to the raw conditions. To account for the diversity in human height, the disclosed systems and methods augment the available human pose data in the height dimension by adding a random offset during training. Additionally, to add smoothness to the output commands and avoid jittery behavior of the robotic device, the disclosed systems and methods pass the predictions through a Gaussian smoothing filter before passing them to the robotic device.

### Discrete Event Prediction

Since mixing continuous and discrete signals in a diffusion process is not straightforward, the disclosed systems and methods add the discrete event predictions as auxiliary tasks to the transformer encoder 400. In some embodiments, the disclosed systems and methods add classification query tokens, specifically q_{b} for discrete behavior and qₛ for style, to the transformer architecture. The output of the transformer encoder has a head prediction of the style s and pre-defined discrete behavior b, respectively. The model learns to select from several classes of hero animations and a default class (i.e., no discrete event occurring). To train the classification heads, the agent 402 uses cross-entropy losses 418.

Inputs to the transformer encoder 400 include one or more conditions 408. The conditions 408 may include one or more of the pose history 412 (e.g., history of the pose 312), command history 414 (e.g., history of the operator commands 304). In some embodiments, the pose history 412 may include the pose of one or more people or devices (e.g., robotic devices). The conditions 408 may be encoded by one or more linear perceptrons 404 (i.e., single layer perceptron networks) or multi-layer perceptrons 406. Other inputs to the transformer encoder 400 may include inputs such as the training data 302. The training data 302 may also be encoded by one or more linear perceptrons 404 or multi-layer perceptrons 406. The outputs of the linear perceptrons 404 or multi-layer perceptrons 406 include one or more input tokens 424. In some embodiments, the input tokens 424 may include encoded numerical embeddings representing pose data and command data. The input tokens 424 may be derived from embedding vectors output by the linear perceptrons 404 or multi-layer perceptrons 406. These inputs, training data 302, and related input tokens 424 may be used to predict continuous agent commands 434 for the robotic device 100.

Inputs to the transformer encoder 400 may also include one or more classification tokens 422. The classification tokens 422 may encode discrete behavior q_{b} and motion style qₛ predictions. The classification tokens 422 may be used by the transformer encoder 400 to predict discrete agent commands 434 for the robotic device 100. The classification token 422 may be passed directly to the transformer encoder 400 without further processing by a perceptron network. In some embodiments, the classification tokens 422 are separately encoded by a linear perceptron 404 or multi-layer perceptron 406.

The agent 402 includes a mask 426 that filters, eliminates, or reduces some of the input tokens 424 generated by the linear perceptrons 404 and/or multi-layer perceptrons 406 based on the conditions 408 and/or the training data 302. Such masking may reduce or prevent the agent 402 from taking incorrect actions such as when an input signal is zero or non-existent. For example, input tokens 424 that lead to unwanted behavior may be screened from the transformer encoder 400 during training or execution. The filtered tokens may be combined with positional encoding data 410 before being inputted to the transformer encoder 400.

The outputs from the transformer encoder 400 include one or more continuous event predictions 430 such as continuous agent commands 434, which may be decoded by a linear perceptron 404 and/or multi-layer perceptron 406 before being fed to the policies 314 that control the robotic device 100. The agent command 434 may be compared to a loss function such as an I² loss function 420 during training of the agent 402, as described further with respect to FIG. 5. An I² loss function 420 function calculates the “squared error loss” or “mean squared error (MSE)” which is the average of the squared differences between the predicted values (e.g., the continuous event predictions 430 from the transformer encoder 400) and the actual target values (e.g., the actual conditions 408 and/or training data 302). The 12 loss function 420 is used to train the transformer encoder 400 to mimic continuous inputs.

Additionally, or alternately, the transformer encoder 400 may output one or more discrete event predictions 432. The discrete event predictions 432 may be decoded by one or more linear perceptrons 404 and/or multi-layer perceptrons 406. The discrete event predictions 432 may be compared to actual discrete events in the training data 302 using a cross-entropy loss function 418 that measures the difference between predicted probability distributions of the discrete event predictions 432 and the true distribution of discrete input events.

The errors generated by the I² loss function 420 and/or the cross-entropy loss function 418 may be used to train the agent 402, for example, as described with respect to FIG. 5.

FIG. 5 illustrates an example method 500 for training an agent 402 disclosed herein. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method 500 includes receiving one or more operator commands 304 at operation 502. For example, the operator 318 may issue one or more discrete or continuous commands (or a combination) from the controller 316, as described herein.

According to some examples, the method 500 includes receiving a pose 312 at operation 508. In various embodiments, the pose 312 may refer to the pose of a person 320 and/or a robotic device 100. The pose 312 of the robotic device 100 may also be received at operation 508. In particular, the method 500 includes receiving the pose 312 of the person 302 relative to the pose 312 robotic device 100. For example, the system 308 may detect the pose and generate a perceptive input 602 included in the training data 302. In some embodiments, the operation 502 and the operation 508 may occur in parallel with one another, in series, or in another order.

According to some examples, the method 500 includes adding noise to the operator command 304 at operation 504. For example, Gaussian noise may be added to the operator command 504.

According to some examples, the method 500 includes encoding the operator command 304 at operation 506. For example, as described with respect to FIG. 4, one or more linear perceptrons 404 and/or multi-layer perceptrons 406 may convert the operator commands 304 (e.g., a command history 414) into one or more input tokens 424 for further processing by the transformer encoder 400.

According to some examples, the method 500 includes encoding the pose 312 of the human (person 320), one or more other people, and/or robotic device 100 at operation 510. For example, as described with respect to FIG. 4, one or more linear perceptrons 404 and/or multi-layer perceptrons 406 may convert the pose 312 into input token 424 for further processing by the transformer encoder 400. In some embodiments, the operation 504 and the operation 510 may occur in parallel with one another, in series, or in another order.

According to some examples, the method 500 includes masking an encoded human pose or robotic device 100 pose 312 (e.g., as encoded in one or more input tokens 424) at operation 512. For example, the agent 402 includes a mask 426 that filters, eliminates, or reduces some of the input tokens 424 generated by the linear perceptrons 404 and/or multi-layer perceptrons 406. Input tokens 424 generated by the operation 510 (e.g., input tokens 424 generated based on the robotic device 100 or person 320 pose 312) may be masked in the operation 512. For example, input tokens 424 that lead to unwanted behavior may be screened from the transformer encoder 400 during training or by the policies 314 during execution. The filtered tokens that pass the mask 426 may be combined with positional encoding data 410 before being inputted to the transformer encoder 400. In some embodiments, the one or more of the input tokens 424 or the output tokens 428 of the transformer encoder 400, may be masked in operation 512 after encoding by the transformer encoder 400.

According to some examples, the method 500 includes de-noising and recovering the input tokens 424 at operation 514. For example, the noised tokens generated by the operations 504 and 506 may be gradually denoised (e.g., in steps determined by a diffusion step 416) to recreate the input tokens 424 as one or more output tokens 428 generated by the linear perceptrons 404 or multi-layer perceptrons 406 into continuous event predictions 430 and/or discrete event predictions 432.

According to some examples, the method 500 includes comparing recovered inputs to the actual input training data 302 via a loss function at operation 516. For example, the continuous event predictions 430 may be compared to the training data 302 by an I² loss function 420. Similarly, the discrete event predictions 432 may be compared to the classification tokens 422 by the cross entropy loss function 418. Operations 514 through 516 may be repeated more than one time for a given set of input training data 302. For example, the method 500 may return from operation 516 to operation 514 based on the diffusion step 416. For example, the iterative denoising process may continue until the diffusion model has completed all diffusion steps. This gradual denoising over multiple steps allows the model to progressively refine the predictions of operator commands.

According to some examples, the method 500 includes determining a diffusion model for the transformer encoder 400 at operation 518. The resulting errors determined in the operation 516 are used to generate weights for nodes in the transformer encoder 400 based on a training algorithm. Once trained, the agent 402 can be deployed to enable a robotic device 100 to autonomously interact with a person 320.

According to some examples, the method 500 includes generating an autonomous command imitating the operator command 304 at operation 520. For example, once the diffusion model is trained, the diffusion model may generate one or more autonomous commands in real time based on the pose 312 of the person 320 sensed by the system. The autonomous commands may imitate the operator commands 304 that would have been issued by the operator 318 in response to the sensed pose 312 of the person 320. In this manner, the diffusion model may replace the human operator 318 at runtime, enabling the robotic device 100 to behave autonomously. For example, the robotic device 100 may autonomously follow the person 320, express different moods or personalities, switch between walking and standing modes, or trigger hero animations, based on the autonomous commands generated by the diffusion model in imitation of the operator 318.

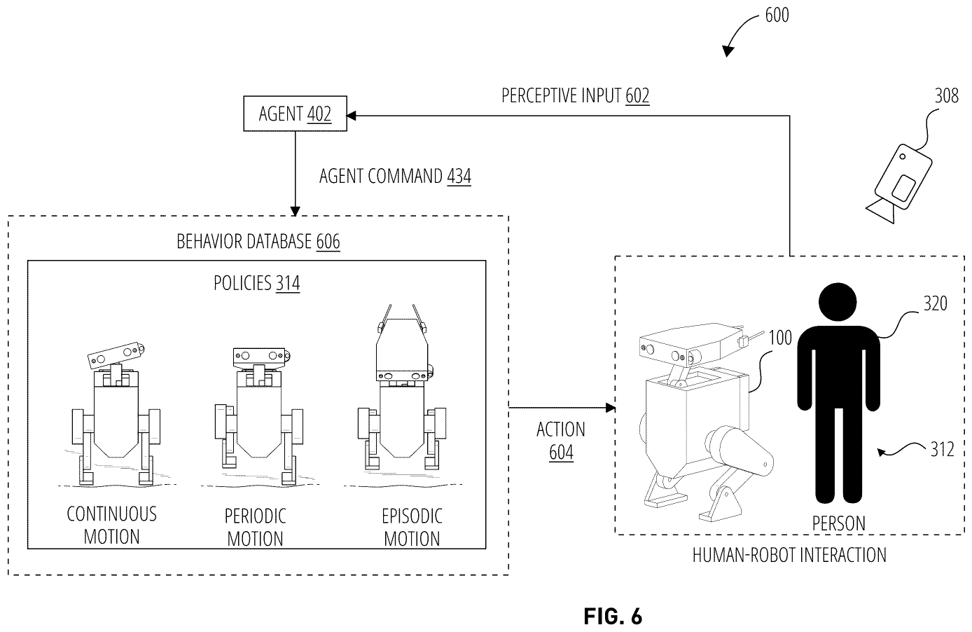

Turning to FIG. 6, a system 600 for controlling a robotic device 100 according to the present disclosure is shown. In the system 600, the operator 318 and the controller 316 are replaced with an agent 402 as described herein. The agent 402 receives information related to the interaction between the robotic device 100 and the person 320. For example, a perception system 308 may detect an aspect of a robotic device 100/person 320 interaction, such as a pose 312 of the person 320 or a pose 312 of the robotic device 100, and generate a perceptive input 602 thereof. The perception system 308 may be incorporated with the robotic device 100 or may be a separate system. In some embodiments, the perception system 308 may be used to train the robotic device 100 e.g., during a training method as shown and described with respect to FIG. 3-FIG. 5. As used herein the perception system 308 is any system that can determine a pose 312 of a human person 320 or an animal, and/or the robotic device 100, such as a motion capture system, machine vision system, pose detection system, or the like.

The perceptive input 602 may be received by the agent 402. For example, the agent 402 may be executed by the controller 102 on the robotic device 100 and may receive a pose 312 of the person 320 and/or robotic device 100.

In some embodiments, a behavior database 606 may store behaviors for the robotic device 100. The behavior database 606 may include different personalities for the robotic device 100, such as a default personality, an angry personality, a curious personality, a joyful personality, and a shy personality. The behavior database 606 may also include continuous motion, periodic motion, and/or episodic motion policies 314. For example, a continuous motion policy may cause the robotic device 100 to stand still. In another example, a periodic motion policy may cause the robotic device 100 to walk, run, or the like. In another example, an episodic motion policy may cause the robotic device to exhibit discrete behaviors or hero animations, such as jumping, dancing, or tantrum animations.

Based on the perceptive input 602 and the agent's 402 training, the agent 402 may issue one or more agent commands 434 interpreted by the policies 314 to cause movement of the robotic device 100. For example, the agent command 434 may instruct the robotic device 100 to perform one or more actions 604 that cause the robotic device 100 to move or react to the person 320. In many embodiments, agent commands 434 are continuous commands (e.g., walk), discrete commands (e.g., turn on head lamp 106) or combinations of these. In some embodiments, the actions 604 caused by the agent command 434 may be perceived by the perception system 308 to generate a second perceptive input 602, thereby causing a repeating loop of interaction of the robotic device 100 and person 320. In some embodiments, the perceptive input 602 may also be included in the training data 302 or further processed by the agent 402.

FIG. 7 is a simplified block diagram of components of a computing system 700 of the robotic device 100, such as the controller 102, or a component of the system 200, system 300, or system 600 such as the controller 316, etc. For example, the processing element 702 and the memory component 708 may be located at one or in several computing systems 700. This disclosure contemplates any suitable number of such computing systems 700. For example, the computing system 700 may be a desktop computing system, a mainframe, a blade, a mesh of computing systems 700, a laptop or notebook computing system 700, a tablet computing system 700, an embedded computing system 700, a system-on-chip, a single-board computing system 700, or a combination of two or more of these. Where appropriate, a computing system 700 may include one or more computing systems 700; be unitary or distributed; span multiple locations; span multiple machines; span multiple data centers; or reside in a cloud, which may include one or more cloud components in one or more networks. A computing system 700 may include one or more processing elements 702, an input/output (I/O) interface 704, one or more external devices 712, one or more memory components 708, and a network interface 710. Each of the various components may be in communication with one another through one or more buses or communication networks, such as wired or wireless networks, e.g., a network. The components in FIG. 7 are exemplary only. In various examples, the computing system 700 may include additional components and/or functionality not shown in FIG. 7.

The processing element 702 may be any type of electronic device capable of processing, receiving, and/or transmitting instructions. For example, the processing element 702 may be a central processing unit, microprocessor, processor, or microcontroller. Additionally, it should be noted that some components of the computing system 700 may be controlled by a first processing element 702 and other components may be controlled by a second processing element 702, where the first and second processing elements may or may not be in communication with each other.

The I/O interface 704 allows an operator to enter data in to computing system 700, as well as provides an input/output for the computing system 700 to communicate with other devices or services. The I/O interface 704 can include one or more input buttons, touch pads, touch screens, and so on.

The external device 712 are one or more devices that can be used to provide various inputs to the computing system 700, e.g., mouse, microphone, keyboard, trackpad, sensing element (e.g., a thermistor, humidity sensor, light detector, etc. The external devices 712 may be local or remote and may vary as desired. In some examples, the external devices 712 may also include one or more additional sensors.

The memory components 708 are used by the computing system 700 to store instructions for the processing element 702 such as for executing the methods disclosed herein, the policies 314, the training data 302, the agent 402, as well as store data, preferences, alerts, etc. The memory components 708 may be, for example, magneto-optical storage, read-only memory, random access memory, erasable programmable memory, flash memory, or a combination of one or more types of memory components.

The network interface 710 provides communication to and from the computing system 700 to other devices. The network interface 710 includes one or more communication protocols, such as, but not limited to Wi-Fi, Ethernet, Bluetooth, etc. The network interface 710 may also include one or more hardwired components, such as a Universal Serial Bus (USB) cable, or the like. The configuration of the network interface 710 depends on the types of communication desired and may be modified to communicate via Wi-Fi, Bluetooth, etc.

The display 706 provides a visual output for the computing system 700 and may be varied as needed based on the device. The display 706 may be configured to provide visual feedback to the operator 318 and may include a liquid crystal display screen, light emitting diode screen, plasma screen, or the like. In some examples, the display 706 may be configured to act as an input element for the operator through touch feedback or the like.

### Experimental Results

Metrics: Defining metrics to measure engaging and natural interactions in simulation is tricky, similar to how it is difficult to define general rules that could be used as heuristics for controlling the robotic device or rewards for learning behavior. To measure and compare different architecture choices, a set of metrics were defined that can give indications about the performance of different models:

Facing Angle Error (FAE): measures the angle between the robotic device's forward direction and the vector from the robotic device's root to the human in degrees. The metric assumes that the robotic device should be facing the human.

Tracking Error (TE): measures the distance between the human and the robotic device in the x-y plane. The metric assumes that the robotic device should follow the human closely.

Mean Squared Derivative (MSD): measures how rapidly the signal changes. This helps identify noisy predictions and abrupt transitions between prediction windows.

### Simulation-Based Ablation

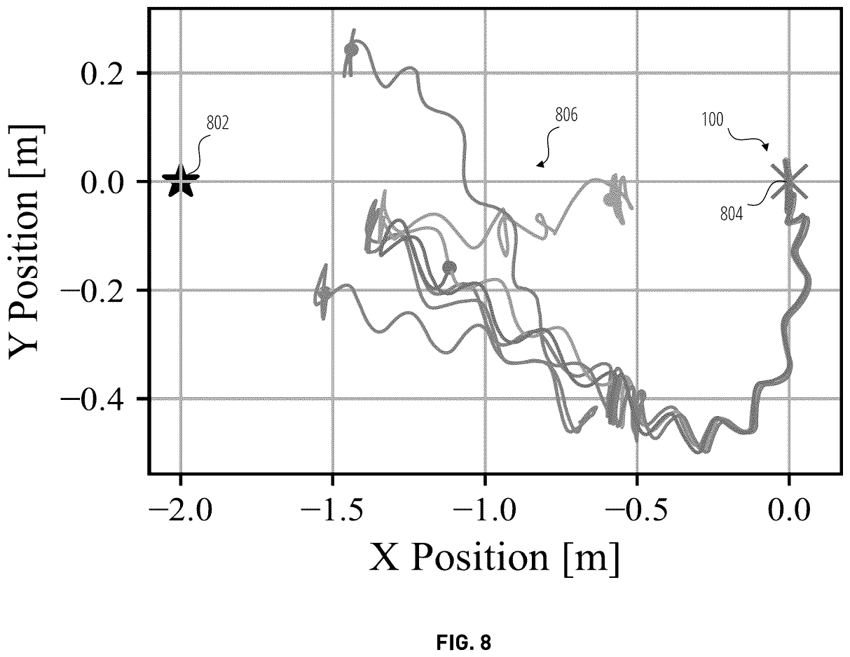

In simulation, the disclosed systems and methods are compared to a transformer-based baseline and ablate design choices of the architecture. Furthermore, the data demonstrate qualitatively in FIG. 8 that given a single starting pose of the robotic device and a fixed human pose, the diffusion-based model generates diverse outputs. As shown for example in FIG. 8, the person 320 occupies a same position 802. The robotic device 100 starts at an initial position 804 different than the position 802 of the person 320. In each of the examples shown, the robotic device starts its motion at the initial position 804. The path lines in FIG. 8 represent different robotic device 100 motion 806 examples based on different person 320 poses 312.

Baseline Comparison: The baseline is a deterministic model that directly maps from human pose as input to operator commands as output. To achieve this, the disclosed systems and methods use the same transformer architecture that is used in the model, but remove the diffusion process. To account for the sequential output, the disclosed systems and methods add query tokens as inputs. As can be seen in Table II (top), the disclosed model achieves better tracking of the human (lower FAE and TE) and leads to a cleaner signal and transitions between prediction windows, as indicated by the lower MSD score. This shows that using a diffusion model is beneficial over using a transformer model without diffusion.

TABLE II
SIMULATION-BASED EVALUATIONS.

| Variant | FAE [deg.] ↓ | TE [m] ↓ | MSD ↓ |
|---|---|---|---|
| transformer | 57.66 ± 19.61 | 1.49 ± 0.05 | 4.40 ± 2.29 |
| Ours 25 frames | 43.85 ± 2.40 | 1.47 ± 0.03 | 2.42 ± 0.40 |
| w/dropout | 39.48 ± 2.19 | 1.44 ± 0.02 | 5.76 ± 0.32 |
| w/o human | 100.28 ± 4.74 | 3.20 ± 0.50 | 2.34 ± 0.26 |
| w/o commands | 43.12 ± 2.66 | 1.44 ± 0.01 | 14.80 ± 0.69 |
| Ours 75 frames | 56.97 ± 1.98 | 1.54 ± 0.01 | 4.11 ± 0.39 |
| Ours 50 frames | 50.58 ± 12.31 | 1.48 ± 0.02 | 2.45 ± 0.33 |
| Ours 25 frames | 43.85 ± 2.40 | 1.47 ± 0.03 | 2.42 ± 0.40 |

Ablations: To ablate different components of the architecture, the disclosed systems and methods train different variants of the model by removing the human pose history p (w/o HP), command history a (w/o HC), dropout (w/o DO). Additionally, the disclosed systems and methods evaluate the influence of different prediction window lengths (25, 50, and 75 frames). See Table II. As expected, the variant without information about the human pose leads to high tracking errors. The variant without conditioning on past commands leads to the best tracking of the human, because no constraints are imposed on the coherency of the signal to previous predictions. Hence, the transitions between windows are often abrupt and jerky, as indicated by the high MSD (14.8). In one variant (e.g., 25 frames) trades off signal coherency with close tracking of the human. When comparing different prediction windows, in one embodiment, 25 frames yields the good tracking performance while staying close to real-time due to the computational load of the diffusion process.

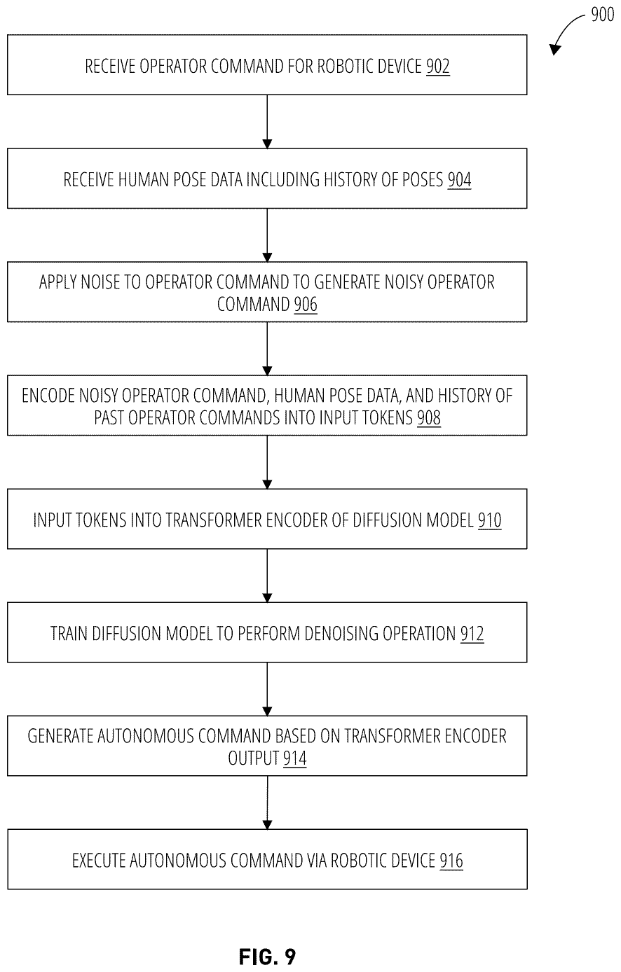

With reference to FIG. 9 an example method 900 for training a diffusion model to enable interaction between a robotic device (e.g., robotic device 100) and a person 320 is shown. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

FIG. 9 illustrates a flowchart for a method 900 of training a diffusion model to enable interaction between a robotic device and a person 320, in accordance with an embodiment of the present disclosure.

At operation 902, an operator command 304 for the robotic device 100 is received via a processing element 702. The operator command 304 may include a continuous command, a discrete command, or a combination thereof. Continuous commands may correspond to analog control inputs such as joystick positions or velocity targets, while discrete commands may correspond to binary or categorical inputs such as button presses or mode selections.

At operation 904, training data 302 such as human pose data including a history of human poses is received via the processing element 702. Robotic device 100 pose data may be received as well. In particular, the human pose data may be received relative to the robotic device 100 pose. The human pose data may include positional and orientational information of the human body or specific body parts over a temporal window. In some embodiments, the human pose data includes a pose of at least one of the person 320 or the robotic device 100.

At operation 906, noise is applied to the operator command 304 to generate a noisy operator command. The noise application follows a diffusion process that progressively corrupts the original operator command 304 according to a noise schedule. This noisy operator command serves as the input for a denoising training objective.

At operation 908, the noisy operator command, the human pose data, and a history of operator commands from the operator 318 and/or one or more other operators are encoded into a plurality of input tokens. The encoding process transforms the heterogeneous input data into a token representation suitable for processing by the transformer architecture.

At operation 910, the plurality of input tokens 424 are input into a transformer encoder of the diffusion model. The transformer encoder processes the input tokens 424 through self-attention mechanisms to capture temporal dependencies and cross-modal relationships between the human pose data and the command history 414.

At operation 912, the diffusion model is trained to perform a denoising operation to generate an autonomous operator command from the noisy operator command based on the human pose data and the history of operator commands. The training objective encourages the diffusion model to learn the reverse diffusion process, enabling prediction of clean operator commands from noisy inputs conditioned on the contextual information.

At operation 914, the autonomous operator command is generated based on an output of the transformer encoder 400. In some embodiments, the output of the transformer encoder 400 is decoded into at least one continuous event prediction, at least one discrete event prediction, or both. When the operator command 304 includes a continuous command, an error between the continuous event prediction and the operator command may be determined based on an I² loss function 420. When the operator command includes a discrete command, a second error between the discrete event prediction and the operator command may be determined based on a cross-entropy cross entropy loss function 418. In some embodiments, one or more of the plurality of input tokens 424 or the output of the transformer encoder 400 is masked. In some embodiments, the masking is applied after encoding by the transformer encoder 400.

At operation 916, the autonomous operator command is executed via the robotic device 100 to cause the robotic device 100 to perform an action during the interaction between the robotic device 100 and the person 320. The execution of the autonomous operator command enables the robotic device to respond appropriately to the person 320 based on the learned relationship between human poses and operator commands.

### Real-World Evaluation

The disclosed systems and methods were tested with qualitative and quantitative real world evaluations. In the empirical evaluations, the disclosed systems and methods can enable 1) interactions with the robotic device that feel similar to interactions controlled by a trained operator and 2) robots to express different moods that are recognizable by people. To this end, in one test a two-stage in-person study analyzed the performance of the disclosed systems and methods and let participants fill out a small questionnaire at the end. In one test, a study with 20 participants, aged between 24 and 44, the questionnaire included the following elements.

Operator Recognition: In this experiment, the tests followed a protocol where each participant experiences one of two settings. In the first setting, the operator is controlling the robotic device to interact with the human in the default mode, following the human around without expressing different moods. In the second setting, the model controls the robotic device to exhibit the same behavior. The results demonstrate each setting to the person for 30 seconds, after which the person has to guess whether it was the model or the operator controlling the robotic device. In total, the test showed each setting twice (4 trials in total) in randomized order. To avoid biasing participants, the operator pretended to be actively controlling the robotic device even in the autonomous setting. The results report the recognition accuracy in a confusion matrix shown in Table. III.

TABLE III
OPERATOR RECOGNITION CONPUSION MATRIX

| | Operator | Autonomous |
|---|---|---|
| Operator | 0.55 | 0.45 |
| Autonomous | 0.46 | 0.54 |

As can be seen, the accuracy is close to 50% with scores of 55% for the operator recognition and 54% for recognizing the autonomous policies. The disclosed autonomous model is classified as operator 46% of the time and the operator is classified as autonomous model 45% of the time. These results indicate that it is difficult for people to tell the two models apart, and that the model in default mode is close to an expert operator's abilities. In one test three participants, who were more experienced technically, figured out tricks to distinguish between the models. For example, these participants figured out that if the robotic device loses track of the human at the border of the mocap space, the model will only start following once inside the tracked space.

Mood Recognition: To determine whether the robotic device can express moods through the approach, one test demonstrated the four moods (happy, sad, angry, shy) to the people (see, e.g., Table. Ifor a detailed description). In one test the order of the moods was randomized between participants let the people interact with the robotic device. An interaction takes 30 seconds, after which people have to provide a forced choice answer. The moods were not explained in detail and simply provide the moods to the people. To avoid external bias, neutral eye coloring was used for the robotic device during this experiment. The results in a confusion matrix shown in Tab. IV, for example.

TABLE IV
MOOD RECOGNITION CONFUSION MATRIX

| | Happy | Sad | Angry | Shy |
|---|---|---|---|---|
| Happy | 0.74 | 0.00 | 0.11 | 0.16 |
| Sad | 0.00 | 0.74 | 0.05 | 0.21 |
| Angry | 0.26 | 0.00 | 0.74 | 0.00 |
| Shy | 0.05 | 0.11 | 0.16 | 0.68 |

Generally, the people were able to correctly select the presented mood with an accuracy between 68% and 74%. The confusion cases give some interesting insights into the perception of certain moods. The angry mood was considered happy (26%) because certain discrete behavior such as the body shaking in disagreement was considered a shake to express excitement. In contrast, the happy mood was considered angry by some (11%) because of the sprint towards the human, which was considered as an aggressive “charging” motion. The sad mood was misclassified as shy (21%) due to the robotic device mostly looking at the ground. These results validate that people can reliably identify the moods, with reasonable explanations for the confused cases, which also shows that there is no clear line between moods and certain behavior is up to interpretation of the person.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method of training a diffusion model to enable autonomous interaction between a robotic device and a human, the method comprising:
receiving, via a processing element, an operator command for the robotic device;
receiving, via the processing element, pose data including a history of poses;
applying, via the processing element, noise to the operator command to generate a noisy operator command;
encoding, via the processing element, the noisy operator command, the pose data, and a history operator commands into a plurality of input tokens;
inputting, via the processing element, the plurality of input tokens into a transformer encoder of the diffusion model;
training, via the processing element, the diffusion model to perform a denoising operation to generate an autonomous command from the noisy operator command based on the pose data and the history of operator commands;
generating, via the processing element, the autonomous command based on an output of the transformer encoder; and
executing, via the robotic device, the autonomous command to cause the robotic device to perform an action during the autonomous interaction between the robotic device and the human.

2. The method of claim 1, further comprising augmenting the pose data in a height dimension by adding a random offset during the training.

3. The method of claim 1, further comprising masking, via the processing element, one or more of the plurality of input tokens or the output of the transformer encoder, wherein the masking is applied after encoding by the transformer encoder.

4. The method of claim 1, wherein the pose data further includes a pose of the robotic device.

5. The method of claim 1, further comprising decoding, via the processing element, the output of the transformer encoder into at least one continuous event prediction.

6. The method of claim 5, wherein the operator command comprises a continuous command, the method further comprising determining, via the processing element, an error between the at least one continuous event prediction and the operator command.

7. The method of claim 6, wherein the processing element determines the error based on an I²-loss function.

8. The method of claim 1, further comprising decoding, via the processing element, the output of the transformer encoder into at least one discrete event prediction.

9. The method of claim 8, wherein the operator command comprises a discrete command, the method further comprising determining, via the processing element, an error between the at least one discrete event prediction and the operator command.

10. The method of claim 9, wherein the processing element determines the error based on a cross-entropy function.

11. A system for training a robotic device to autonomously interact with a human, the system comprising:
a robotic device;
a controller in communication with the robotic device and configured to receive an operator command for the robotic device;
a perceptive input system configured to determine pose data including a history of poses; and
a processing element configured to:
apply noise to the operator command to generate a noisy operator command,
encode the noisy operator command, the pose data, and a history of operator commands into a plurality of input tokens,
input the plurality of input tokens into a transformer encoder of a diffusion model,
train the diffusion model to perform a denoising operation to generate an autonomous command from the noisy operator command based on the pose data and the history of operator commands; and
generate the autonomous command based on an output of the transformer encoder, wherein the robotic device is configured to:
execute the autonomous command to cause the robotic device to perform an action during the autonomous interaction with the human.

12. The system of claim 11, wherein the processing element is further configured to augment the pose data in a height dimension by adding a random offset during the training.

13. The system of claim 11, wherein the processing element masks one or more of the plurality of input tokens or the output of the transformer encoder, and the masking is applied after encoding by the transformer encoder.

14. The system of claim 11, wherein the pose data further includes a pose of the robotic device.

15. The system of claim 11, wherein the processing element decodes the output of the transformer encoder into at least one continuous event prediction.

16. The system of claim 15, wherein the operator command comprises a continuous command, and the processing element is configured to determine an error between the at least one continuous event prediction and the operator command.

17. The system of claim 16, wherein the processing element determines the error based on an I² loss function.

18. The system of claim 11, wherein the processing element decodes the output of the transformer encoder into at least one discrete event prediction.

19. The system of claim 18, wherein the operator command comprises a discrete command and the processing element is configured to determine a second error between the at least one discrete event prediction and the operator command.

20. The system of claim 19, wherein the processing element determines the error based on a cross-entropy function.
